(19) United States
(12) Patent Application Publication
(10) Pub. No.: US 2020/0209717 A1
(43) Pub. Date: Jul. 2, 2020

(54) CAMERA MODULE, DISPLAY MODULE, AND TERMINAL DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventors: Hong GAO, Wuhan, Hubei (CN); Mugyeom KIM, Wuhan, Hubei (CN); Yong ZHAO, Wuhan, Hubei (CN)

(21) Appl. No.: 16/484,534

(22) PCT Filed: Apr. 17, 2019
(86) PCT No.: PCT/CN2019/082958

§ 371 Date: Aug. 8, 2019

(30) Foreign Application Priority Data
Dec. 28, 2018 (CN) 201811618085.4

(51) Int. Cl. G03B 17/12; G02B 7/09; G03B 13/36

(52) U.S. Cl. CPC G03B 17/12; G03B 13/36; G02B 7/09

(57) ABSTRACT

A camera module is provided, which includes a lens assembly and an image sensor, wherein the lens assembly includes a housing, an upper lens and a lower lens disposed in the housing; the upper lens and the lower lens are oppositely disposed, and an incident light passes through the upper lens and the lower lens to enter the image sensor; at least one of the upper lens and the lower lens is a plano-convex lens, the plano-convex lens has a planar shape on one surface and a curved convex shape on the other surface. The camera module adopts a novel optical path design, such that it cooperates with the display screen disposed thereon better, so that the display screen can achieve a “full screen display” effect to a certain extent.

### FIELD OF INVENTION

The invention relates to the technical field of camera components, and, in particular, to a camera module for being positioned under the display screen and a display module and a terminal device having the camera module.

### BACKGROUND OF INVENTION

With the continuous advancement of technology, touch-screen mobile phones have become an indispensable tool for people's daily lives, and screen-to-body ratio and photographing performance have become two important considerations for people to buy mobile phones.

In this regard, the industry has developed a “full screen display” mobile phone, and with the continuous development of technology, the screen-to-body ratio of the “full screen display” is getting higher and higher. However, due to the user's photographing demands, a front camera at the bottom of the screen is always required, such that a portion of the “full screen display” is always needed to provide a channel for incident light to reach the camera under the screen, whereby the screen in fact cannot be a full screen.

In this regard, the industry endeavors to constantly research and develop to provide solution. On the one hand, the industry hopes to provide a display screen which ensures the incidence of light without affecting the display, and, on the other hand, to provide a camera module with a better performance, and the camera can ensure the photographing performance and cooperate with the display screen to achieve the full screen display effect.

### SUMMARY OF INVENTION

This invention provides a camera module which adopts a novel optical path design, such that it cooperates with the display screen disposed thereon well, so that the display screen can achieve a “full screen display” effect to a certain extent.

The technical solution adopted by the invention is as follows:

A camera module, includes a lens assembly and an image sensor, wherein the lens assembly includes a housing, an upper lens and a lower lens disposed in the housing; wherein the upper lens and the lower lens are oppositely disposed, and an incident light passes through the upper lens and the lower lens to enter the image sensor; wherein at least one of the upper lens and the lower lens is a plano-convex lens, the plano-convex lens has a planar shape on one surface and a curved convex shape on the other surface.

The plano-convex lens can have a configuration substantially being a half of the whole lens. For example, it may be formed by cutting a whole lens in half, and the curvature of the convex surface of the half lens after the cutting is greater than or equal to the radius of curvature of the whole lens before the cutting. However, the specific thickness of the planar shape and the convex curvature radius of the plano-convex lens after the cutting can be adjusted according to actual needs, and there is no limitation.

Further, in another embodiment, wherein the upper lens is the plano-convex lens, and the curved convex shape faces the image sensor.

Further, in another embodiment, wherein an incident angle θ1 of the incident light entering the upper lens is greater than a refraction angle θ2 of the incident light exiting the upper lens, and wherein the incident angle θ1 is an angle between the incident light and a normal line to the curved convex shape of the upper lens, and the refraction angle θ2 is the angle between the incident light exiting the curved convex shape and a tangent line to the curved convex shape of the upper lens, and the normal line and the tangent line are perpendicular to each other.

Further, in another embodiment, wherein an edge of the upper lens extends out of the housing, such that the upper lens can be prevented from being blocked by the housing, so that more incident light can be received.

Further, in another embodiment, wherein the lower lens is the plano-convex lens, and the curved convex shape faces away from the image sensor.

Further, in another embodiment, wherein an incident angle θ3 of the incident light entering the lower lens is greater than a refraction angle θ4 of the incident light exiting the lower lens, wherein the incident angle θ3 is the angle between the incident light and a tangent line to the curved convex shape of the lower lens, the refraction angle θ4 is the angle between the incident light exiting the curved convex shape and a normal line to the curved convex shape of the lower lens, and the normal line and the tangent line are perpendicular to each other.

Further, in another embodiment, wherein a projection size of the lower lens from a top view is larger than a projection size of the image sensor disposed from the same aspect of viewing, such that the light transmitted through the lower lens can enter the image sensor from more positions, and there is no problem that the edge position of the image sensor does not receive the incident light, thereby affecting the image quality.

Further, in another embodiment, wherein the upper lens and the lower lens are both plano-convex lenses, and wherein the curved convex surface of the upper lens faces the curved convex surface of the lower lens.

Further, in another embodiment, wherein the housing is further provided with a focusing component capable of moving the upper lens and/or the lower lens to perform auto focusing according to an instruction.

Further, another embodiment of this invention provides a display module, which includes a display screen and a camera module of this invention on a side of the display screen, wherein the display screen includes a display area and a light transmission area located in the display area, and the camera module is aligned with the light transmission area.

Further, another embodiment of this invention provides a terminal device, which includes a body, wherein a display screen and a camera module of the invention are disposed on the body; wherein the display screen includes a PI layer, and the camera module is disposed under the PI layer.

Further, in another embodiment, the terminal device may be any smart terminal device that needs to set a display screen and set a camera module under the display screen. For example, mobile phones, tablets, computers, and so on.

Further, in another embodiment, wherein the display screen includes an organic light-emitting diode (OLED) display screen, preferably an active-matrix organic light-emitting diode (AMOLED) display screen, wherein a polyamide (PI) layer is provided with an OLED functional layer and a glass layer.

Compared with the prior art, the beneficial effect of the present invention is: the invention relates to a camera module, wherein the upper lens and the lower lens of the lens assembly adopt a novel thinned lens design, thereby introducing a novel optical path design, such that it cooperates with the display screen disposed thereon better, so that the display screen can achieve a “full screen display” effect to a certain extent.

### DESCRIPTION OF DRAWINGS

In order to more clearly illustrate the technical solutions in the embodiments of the present invention, the drawings used in the description of the embodiments will be briefly described below. It is obvious that the drawings in the following description are only some embodiments of the present invention. Other drawings can also be obtained from those skilled in the art based on these drawings without paying any creative effort.

FIG. 1 is a schematic structural diagram of a camera module according to an embodiment of the present invention.

FIG. 2 is a schematic diagram of the optical path of the camera module shown in FIG. 1.

FIG. 3 is a schematic diagram showing the positional relationship between the camera module shown in FIG. 1 and the display screen.

### DETAILED DESCRIPTION OF PREFERRED EMBODIMENTS

The technical solution of a camera module, a display module and a terminal device having the camera module according to the present invention will be further described in detail below with reference to the accompanying drawings and embodiments.

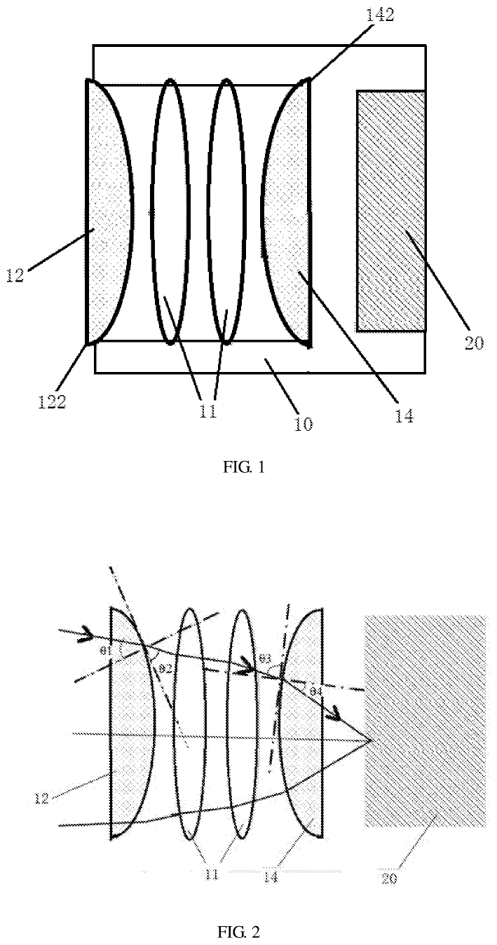

Please refer to FIG. 1, an embodiment of the present invention provides a camera module including a lens assembly and an image sensor 20.

The lens assembly includes a housing 10 in which an upper lens 12, a light transmissive element 11 and a lower lens 14 are oppositely disposed. An incident light enters an image sensor 20 through the upper lens 12, the light transmitting element 11 and the lower lens 14 in the lens assembly.

The upper lens 12 and the lower lens 14 adopt a configuration of a novel plano-convex lens, wherein the plano-convex lens has a planar shape on one surface and a curved convex shape on the other surface. The curved convex surfaces of the upper lens 12 and the lower lens 14 are disposed toward each other; that is, the plane of the lower lens 14 faces the image sensor 20, and the curved convex surface of the lower lens 14 faces the curved convex surface of the upper lens.

The plano-convex lens can have a configuration substantially being a half of a whole lens. For example, it may be formed by cutting a whole lens in half, and the curvature of the convex surface of the half lens after the cutting is greater than or equal to the radius of curvature of the whole lens before the cutting. However, the specific thickness of the planar portion and the convex curvature radius of the plano-convex lens after the cutting can be adjusted according to actual needs, and there is no limitation.

Please refer to FIG. 2, which illustrates the transmitting path of incident light in the camera module. As shown in the figure, an incident angle θ1 of the incident light entering the upper lens 12 is greater than a refraction angle θ2 of the light after it passes through the upper lens, wherein the incident angle θ1 is the angle between the incident light and the normal line to the curved convex shape of the upper lens 12, and the refraction angle θ2 is the angle between the incident light exiting the curved convex shape and the tangent line to the curved convex shape of the upper lens 12, and the normal line and the tangent line are perpendicular to each other.

An incident angle θ3 of the incident light entering the lower lens 14 is greater than a refraction angle θ4 of the incident light exiting the lower lens 14, wherein the incident angle θ3 is the angle between the incident light and the tangent line to the curved convex shape of the lower lens 14, the refraction angle θ4 is the angle between the incident light exiting the curved convex shape and the normal line to the curved convex shape of the lower lens 14, and the normal line and the tangent line are perpendicular to each other.

Further, in another embodiment, the peripheral edge 122 of the upper lens 12 extends out of the housing 10 to enable receiving more light into the lens assembly. The peripheral edge 142 of the lower lens 14 is also beyond the peripheral edge of the image sensor 20 disposed behind; that is, a projection size of the lower lens 14 from a top view is greater than a projection size of the image sensor 20 from the same aspect of viewing. The projection size is set in such a manner that all of the regions of the image sensor 20 can receive the incident light transmitted through the lower lens 14.

Further, in another embodiment, the housing 10 is further provided with a focusing component capable of moving the upper lens and/or the lower lens to perform auto focusing according to an instruction. This focusing component can be a well-known component in the industry. The light transmissive element 11 disposed between the upper lens 12 and the lower lens 14 is also a well-known component in the art, which is only schematically illustrated in FIG. 1.

Further, another embodiment of the present invention provides a display module, which includes a display screen and the camera module according to the present invention on a side of the display screen. The display screen includes a display area and a light transmission area located in the display area, and the camera module is aligned with the light transmission area.

Further, still another embodiment of the present invention provides a terminal device, which includes a body. The display screen and the camera module of the present invention are disposed in the body, wherein the camera module is disposed under the display screen as a front camera module.

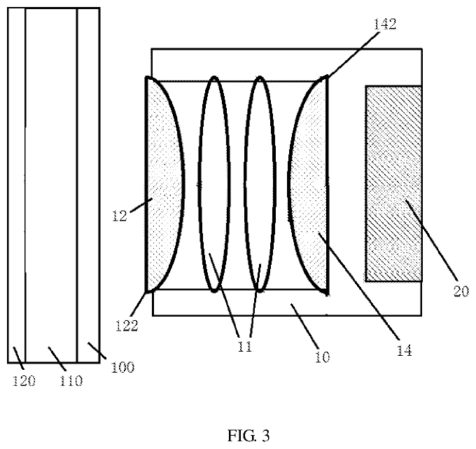

Please refer to FIG. 3, which illustrates the positional relationship between the camera module and the display screen according to the present invention. The display screen is an organic light-emitting diode (OLED) display screen, preferably an active-matrix organic light-emitting diode (AMOLED) display screen, which includes a polyamide (PI) layer 100 and an OLED functional layer 110 and a glass layer 120 disposed thereon. The camera module is disposed below the PI layer 100.

The planar shape of the upper lens 12 of the camera module faces outward toward the PI layer 100; the curved convex shape thereof faces inward toward the image sensor 20; and the planar shape of the lower lens 14 faces outward toward the image sensor 20. The curved convex shape thereof faces inward toward the curved convex shape of the upper lens 12; that is, the curved convex surfaces of the upper lens 12 and the lower lens 14 are disposed to face each other.

Further, in another embodiment, the terminal device may be any smart terminal device that needs to set a display screen and set a camera module under the display screen. For example, mobile phones, tablets, computers, and so on.

The invention relates to a camera module, wherein the upper lens and the lower lens of the lens assembly adopt a novel thinned lens design, thereby introducing a novel optical path design, such that it cooperates with the display screen disposed thereon better, so that the display screen can achieve a screen display effect to a certain extent.

The technical scope of the present invention is not limited to the above description, and those skilled in the art can make various modifications and changes to the above embodiments without departing from the technical idea of the present invention, and these modifications and changes are all within the scope of the present invention.

1. A camera module, comprising a lens assembly and an image sensor, wherein the lens assembly comprises a housing, an upper lens and a lower lens disposed in the housing;
wherein the upper lens and the lower lens are oppositely disposed, and an incident light passes through the upper lens and the lower lens to enter the image sensor;
wherein at least one of the upper lens and the lower lens is a plano-convex lens, the plano-convex lens has a planar shape on one surface and a curved convex shape on the other surface.

2. The camera module as claimed in claim 1, wherein the upper lens is the plano-convex lens, and the curved convex shape faces the image sensor.

3. The camera module as claimed in claim 2, wherein an incident angle θ1 of the incident light entering the upper lens is greater than a refraction angle θ2 of the incident light exiting the upper lens, and wherein the incident angle θ1 is an angle between the incident light and a normal line to the curved convex shape of the upper lens, the refraction angle θ2 is the angle between the incident light exiting the curved convex shape and a tangent line to the curved convex shape of the upper lens, and the normal line and the tangent line are perpendicular to each other.

4. The camera module as claimed in claim 1, wherein an edge of the upper lens extends out of the housing.

5. The camera module as claimed in claim 1, wherein the lower lens is the plano-convex lens, and the curved convex shape faces away from the image sensor.

6. The camera module as claimed in claim 5, wherein an incident angle θ3 of the incident light entering the lower lens is greater than a refraction angle θ4 of the incident light exiting the lower lens, wherein the incident angle θ3 is the angle between the incident light and a tangent line to the curved convex shape of the lower lens, the refraction angle θ4 is the angle between the incident light exiting the curved convex shape and a normal line to the curved convex shape of the lower lens, and the normal line and the tangent line are perpendicular to each other.

7. The camera module as claimed in claim 1, wherein a projection size of the lower lens from a top view is larger than a projection size of the image sensor disposed from the same aspect of viewing.

8. The camera module as claimed in claim 1, wherein the housing is further provided with a focusing component capable of moving the upper lens and/or the lower lens to perform auto focusing according to an instruction.

9. A display module, comprising a display screen and a camera module on a side of the display screen, wherein the display screen comprises a display area and a light transmission area located in the display area;
wherein the camera module is the camera module as claimed in claim 1, wherein the camera module is aligned with the light transmission area.

10. A terminal device, comprising a body, wherein a display screen and a camera module are disposed on the body;
wherein the camera module is the camera module as claimed in claim 1;
wherein the display screen comprises a PI layer, and the camera module is disposed under the PI layer.

11. A display module, comprising a display screen and a camera module on a side of the display screen, wherein the display screen comprises a display area and a light transmission area located in the display area;
wherein the camera module is the camera module as claimed in claim 2, wherein the camera module is aligned with the light transmission area.

12. A display module, comprising a display screen and a camera module on a side of the display screen, wherein the display screen comprises a display area and a light transmission area located in the display area;
wherein the camera module is the camera module as claimed in claim 3, wherein the camera module is aligned with the light transmission area.

13. A display module, comprising a display screen and a camera module on a side of the display screen, wherein the display screen comprises a display area and a light transmission area located in the display area;
wherein the camera module is the camera module as claimed in claim 5, wherein the camera module is aligned with the light transmission area.

14. A display module, comprising a display screen and a camera module on a side of the display screen, wherein the display screen comprises a display area and a light transmission area located in the display area;
wherein the camera module is the camera module as claimed in claim 6, wherein the camera module is aligned with the light transmission area.

15. A display module, comprising a display screen and a camera module on a side of the display screen, wherein the display screen comprises a display area and a light transmission area located in the display area;
wherein the camera module is the camera module as claimed in claim 7, wherein the camera module is aligned with the light transmission area.

16. A terminal device, comprising a body, wherein a display screen and a camera module are disposed on the body;
wherein the camera module is the camera module as claimed in claim 2;
wherein the display screen comprises a PI layer, and the camera module is disposed under the PI layer.

17. A terminal device, comprising a body, wherein a display screen and a camera module are disposed on the body;
wherein the camera module is the camera module as claimed in claim 3;
wherein the display screen comprises a PI layer, and the camera module is disposed under the PI layer.

18. A terminal device, comprising a body, wherein a display screen and a camera module are disposed on the body;
wherein the camera module is the camera module as claimed in claim 5;
wherein the display screen comprises a PI layer, and the camera module is disposed under the PI layer.

19. A terminal device, comprising a body, wherein a display screen and a camera module are disposed on the body;
wherein the camera module is the camera module as claimed in claim 6;
wherein the display screen comprises a PI layer, and the camera module is disposed under the PI layer.

20. A terminal device, comprising a body, wherein a display screen and a camera module are disposed on the body;
wherein the camera module is the camera module as claimed in claim 7;
wherein the display screen comprises a PI layer, and the camera module is disposed under the PI layer.
